(19) United States
(12) Patent Application Publication
(10) Pub. No.: US 2024/0165610 A1
(43) Pub. Date: May 23, 2024

(54) MICROFLUIDIC CHIP

(71) Applicant: Shanghai Tianma Micro-Electronics Co., Ltd., Shanghai (CN)

(72) Inventors: Baiquan LIN, Shanghai (CN); Kerui XI, Shanghai (CN); Ping SU, Shanghai (CN); Linzhi WANG, Shanghai (CN); Yian ZHOU, Shanghai (CN); Feng QIN, Shanghai (CN); Junting OUYANG, Shanghai (CN)

(73) Assignee: Shanghai Tianma Micro-Electronics Co., Ltd., Shanghai (CN)

(21) Appl. No.: 17/758,357

(22) PCT Filed: Jul. 19, 2021
(86) PCT No.: PCT/CN2021/107141

§ 371 Date: Jul. 5, 2022

(30) Foreign Application Priority Data
Apr. 27, 2021 (CN) 202110462186.2

(51) Int. Cl. B01L 3/00

(52) U.S. Cl. CPC B01L 3/502715; B01L 2300/0645; B01L 2400/0427

(57) ABSTRACT

Provided is a microfluidic chip. The microfluidic chip includes a first substrate and a second substrate disposed opposite to each other, a microfluidic channel formed between the first substrate and the second substrate and configured to accommodate at least one droplet, drive electrodes arranged in an array and sensing electrodes disposed on a side of the first substrate. Each sensing electrode includes at least one first branch electrode and at least one second branch electrode. The first branch electrode extends along a first direction, and the second branch electrode extends along a second direction. Different drive voltage signals are applied to adjacent drive electrodes to drive the droplet to move. Detection signals are applied to the sensing electrodes, and a position of the droplet is determined according to a change in capacitance between one sensing electrode and an electrode corresponding thereto when the droplet flows by.

### CROSS-REFERENCE TO RELATED APPLICATIONS

This is a National Stage Application filed under 35 U.S.C. 371 based on International Patent Application No. PCT/CN2021/107141, filed on Jul. 19, 2021, which claims priority to Chinese Patent Application No. 202110462186.2 filed on Apr. 27, 2021, the disclosures of both of which are incorporated herein by reference in their entireties.

### FIELD

Embodiments of the present application relate to the field of microfluidics technology and, for example, to a microfluidic chip.

### BACKGROUND

Microfluidics technology refers to a technology that uses micro-channels (tens to hundreds of microns in dimension) to process or manipulate microscopic fluids (volumes ranging from nanoliter to attoliter). A microfluidic chip is a main platform for achieving the microfluidics technology. The microfluidic chip has characteristics of parallel collection and processing of samples, high integration, high throughput, fast analysis speed, low power consumption, low material consumption, and low pollution. The microfluidic chip technology may be applied to biological genetic engineering, disease diagnosis and drug research, cell analysis, environmental monitoring and protection, health quarantine, forensic identification and other fields.

When the surface of a drive unit is uneven or contains impurities due to raw material, process or environmental problems, a droplet motion state is affected. Since drive timing is determined in advance, if no droplet position feedback mechanism exists, the subsequent process is affected. It is difficult for the experimenter to know the preceding case, and reducing the experimental efficiency and even causing the experiment to fail. Especially in experiments with complicated droplet moving paths, real-time feedback of the droplet position is more important.

In the microfluidics technology, it is usually difficult to feedback the droplet position in real time. Some literatures mention that the droplet position may be obtained by optical detection, but in this method, an external laser device usually needs to be equipped, which is complicated in structure, difficult for on-site real-time diagnosis, and has a relatively high cost.

### SUMMARY

Embodiments of the present application provide a microfluidic chip. The microfluidic chip may acquire a position of a droplet while driving liquid to move, and to solve the problem of low reliability of a device due to the inability to detect the position of the droplet in the related art.

An embodiment of the present application provides a microfluidic chip. The microfluidic chip includes a first substrate and a second substrate disposed opposite to each other, where a microfluidic channel is formed between the first substrate and the second substrate and configured to accommodate at least one droplet.

A plurality of drive electrodes and a plurality of sensing electrodes disposed on a side of the first substrate are further included, where the plurality of drive electrodes are arranged in an array, and a projection of each of the plurality of sensing electrodes on a plane where the first substrate is located at least partially overlaps with a projection of a slit between two drive electrodes of the plurality of drive electrodes adjacent to the each of the plurality of sensing electrodes on the plane where the first substrate is located.

Each of the plurality of sensing electrodes includes at least one first branch electrode and at least one second branch electrode, the at least one first branch electrode extends along a first direction, the at least one second branch electrode extends along a second direction, the first direction is parallel to a row direction of the array where the plurality of drive electrodes are arranged, and the second direction is parallel to a column direction of the array where the plurality of drive electrodes are arranged.

Different drive voltage signals are applied to adjacent ones of the plurality of drive electrodes, and to drive the at least one droplet to move.

Detection signals are applied to the plurality of sensing electrodes, and a position of the at least one droplet is determined according to a change in capacitance between one of the plurality of sensing electrodes and an electrode corresponding to the one of the plurality of sensing electrodes when the at least one droplet flows by.

### BRIEF DESCRIPTION OF DRAWINGS

FIG. 1 is a structural diagram of a microfluidic chip in the related art;

FIG. 2 is a structural diagram of another microfluidic chip in the related art;

FIG. 3 is a structural diagram of a microfluidic chip according to an embodiment of the present application;

FIG. 4 is a sectional diagram taken along line AA′ of FIG. 3;

FIG. 5 is another sectional diagram taken along line AA′ of FIG. 3;

FIG. 6 is a structural diagram of another microfluidic chip according to an embodiment of the present application;

FIG. 7 is a structural diagram of another microfluidic chip according to an embodiment of the present application;

FIG. 8 is a structural diagram of another microfluidic chip according to an embodiment of the present application;

FIG. 9 is a structural diagram of another microfluidic chip according to an embodiment of the present application;

FIG. 10 is a structural diagram of another microfluidic chip according to an embodiment of the present application;

FIG. 11 is a structural diagram of another microfluidic chip according to an embodiment of the present application;

FIG. 12 is a structural diagram of another microfluidic chip according to an embodiment of the present application;

FIG. 13 is a structural diagram of another microfluidic chip according to an embodiment of the present application;

FIG. 14 is a structural diagram of a circuit of a microfluidic chip according to an embodiment of the present application;

FIG. 15 is a sectional diagram of a microfluidic chip according to an embodiment of the present application;

FIG. 16 is a sectional diagram of another microfluidic chip according to an embodiment of the present application;

FIG. 17 is a structural diagram of another microfluidic chip according to an embodiment of the present application; and

FIG. 18 is a sectional diagram taken along line BB′ of FIG. 17.

### DETAILED DESCRIPTION

Hereinafter the present application is described in detail in conjunction with the drawings and embodiments.

Terms used in the embodiments of the present application are merely used to describe the embodiments and not intended to limit the present application. It is to be noted that spatially related terms, including “on”, “below”, “left” and “right” described in the embodiments of the present application, are described from the perspective of the drawings and are not to be construed as a limitation to the embodiments of the present application. In addition, in the context, it is to be understood that when a component is formed “on” or “below” another component, the component may not only be directly formed “on” or “below” another component and may also be indirectly formed “on” or “below” another component via an intermediate component. Terms “first”, “second” and the like are merely used for description and distinguishing between different components rather than indicating any order, quantity, or importance.

The research of the microfluidic chip began in the early 1990s. The microfluidic chip is a potential technology to achieve Lab-on-a-chip and can integrate basic operation units such as sample preparation, reaction, separation and detection in the biological, chemical and medical analysis processes into a micro-scale chip, a network is formed by a micro-channel, and the controllable fluid runs through the whole system, and to replace various functions of conventional biological or chemical laboratories and automatically complete the whole process of analysis. Due to the great potential in integration, automation, portability, and high efficiency, the microfluidic chip technology has become a current research hotspot and one of the world's cutting-edge technologies. In the past two decades, the digital microfluidic chip has shown a booming trend in laboratory research and industrial applications, especially the digital microfluidic chip based on microdroplet manipulation has made great progress. The volume of a manipulated droplet may reach the microliter or even nanoliter level and at the micro scale, the microliter and nanoliter level droplet may be mixed more accurately, and the chemical reaction inside the droplet is more sufficient. In addition, different biochemical reaction processes inside the droplet may be monitored, and the microdroplet may contain cells and biomolecules, such as proteins and DNA, and enabling higher-throughput monitoring. Among many methods for driving the microdroplet, in the traditional method, the generation and control of the microdroplet are achieved in the micro-channel. However, the manufacturing process of the micro-channel is rather complicated, the micro-channel is easily blocked, the reusability is not high, and complicated peripherals are required for driving.

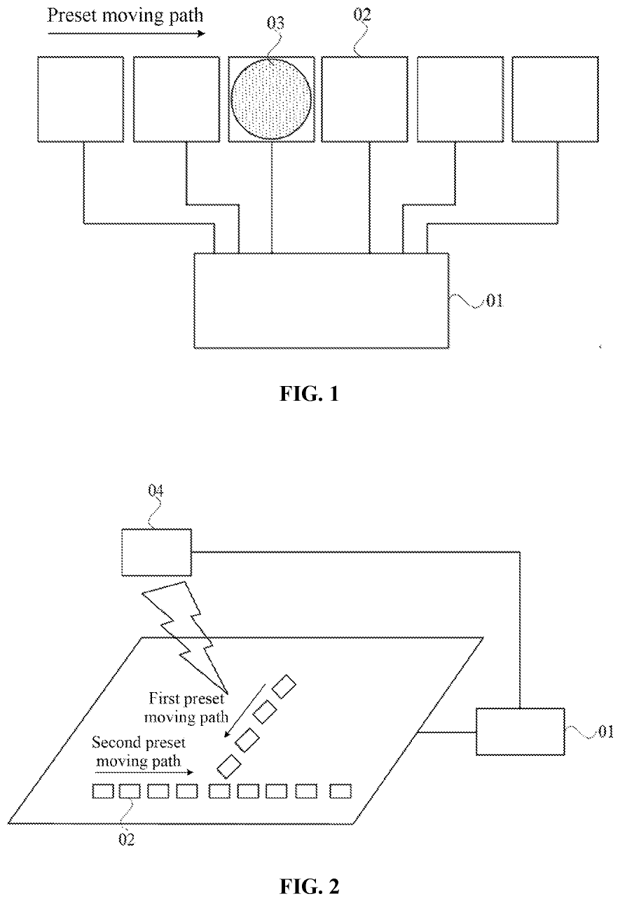

With many advantages, the dielectric wetting effect is increasingly used for manipulating microdroplets in the digital microfluidic chip. Since the microfluidic chip based on dielectric wetting does not require complicated equipment such as micro-channels, micropumps and microvalves, the manufacturing process is simple, the heat generation is small, the response is fast, the power consumption is low, and the packaging is simple. The microfluidic chip based on the dielectric wetting effect may achieve the distribution, separation, transportation and merging of the microdroplets. However, the digital microfluidic chip based on electro-wetting-on-dielectric use electrodes as control units to manipulate droplets, so a large number of electrode units are required. Exemplarily, FIG. 1 is a structural diagram of a microfluidic chip in the related art. Referring to FIG. 1, the microfluidic chip includes a control circuit 01 and multiple drive units 02, and each drive unit 02 is electrically connected to the control circuit 01 and configured to drive a droplet 03 to flow according to a preset moving path. This microfluidic chip has advantages of a simple structure and low costs, but this microfluidic chip cannot feedback a position of the droplet in real time, and limiting application scenarios. FIG. 2 is a structural diagram of another microfluidic chip in the related art. Referring to FIG. 2, the microfluidic chip includes a control circuit 01, multiple drive units 02, and a laser head 04. The drive units 02 and the laser head 04 are all electrically connected to the control circuit 01, the drive units 02 are configured to drive the droplet to move, the laser head 04 emits a laser beam for detecting the position of the droplet, and the optical detection method is used for achieving the droplet positioning, which is complicated in structure, difficult for on-site real-time diagnosis, and has a relatively high cost.

An embodiment of the present application provides a microfluidic chip. The microfluidic chip includes a first substrate and a second substrate disposed opposite to each other and multiple drive electrodes and multiple sensing electrodes disposed on a side of the first substrate. A microfluidic channel is formed between the first substrate and the second substrate and configured to accommodate at least one droplet. The multiple drive electrodes are arranged in an array, and a projection of each sensing electrode on a plane where the first substrate is located at least partially overlaps with a projection of a slit between adjacent drive electrodes on the plane where the first substrate is located. Each sensing electrode includes at least one first branch electrode and at least one second branch electrode, the at least one first branch electrode extends along a first direction, the at least one second branch electrode extends along a second direction, the first direction is parallel to a row direction of the array where the multiple drive electrodes are arranged, and the second direction is parallel to a column direction of the array where the multiple drive electrodes are arranged. Different drive voltage signals are applied to adjacent drive electrodes among the multiple drive electrodes, and to drive the droplet to move. Detection signals are applied to the multiple sensing electrodes, and a position of the droplet is determined according to a change in capacitance between one sensing electrode and an electrode corresponding to the sensing electrode when the droplet flows by.

Both the first substrate and the second substrate may be glass substrates, a sealant is arranged between the first substrate and the second substrate and to form at least one microfluidic channel for accommodating the droplet for the droplet to move, and the drive electrodes may be configured to be bulk electrodes arranged on the first substrate in an array and may be formed by metal oxides (for example, indium tin oxide (ITO)). An area of one drive electrode is less than an area of a projection of the droplet on the first substrate. When the droplet is driven to move, different drive voltages are applied to adjacent drive electrodes, and the droplet is driven by a differential voltage between the adjacent drive electrodes and controlled to move according to a preset path. Since the drive electrodes are arranged in an array and discretely, electrodes may be arranged between the drive electrodes and to form capacitors. When the droplet flows by, a capacitance of the capacitor changes and the position of the droplet is acquired. In the embodiments of the present application, multiple sensing electrodes are on the first substrate, and each sensing electrode includes at least one first branch electrode extending along the first direction (the row direction of the drive electrode array) and at least one second branch electrode extending along the second direction (the column direction of the drive electrode array). At least part of the first branch electrode is disposed in a slit between two adjacent rows of drive electrodes, and at least part of the second branch electrode is disposed in a slit between two adjacent columns of drive electrodes, instead of being completely below the drive electrodes, and to prevent the drive electrodes from shielding signals of the sensing electrodes. When the position of the droplet is detected, a corresponding voltage is applied to the sensing electrode, and at least one sensing electrode and an electrode in the microfluidic chip form a capacitor. An electrode may be a common electrode arranged on the second substrate, a trace in the first substrate, or an electrode of other capacitors and only needs to form a capacitor with the corresponding sensing electrode. When the droplet flows by through a position, due to the influence of the droplet, a size of the capacitance between at least one sensing electrode at the position changes, and the change of the capacitance is detected and to acquire the position of the droplet.

In the embodiments of the present application, the microfluidic channel is formed between the first substrate and the second substrate and configured to accommodate at least one droplet; multiple drive electrodes are arranged on a side of the first substrate in an array, and different drive voltage signals are applied to adjacent drive electrodes, and to drive the droplet to move; multiple sensing electrodes are disposed on a side of the first substrate, detection signals are applied to multiple sensing electrodes, and the position of the droplet is determined according to a change in capacitance between the sensing electrode and an electrode corresponding to the sensing electrode when the droplet flows by; the projection of the sensing electrode on the plane where the first substrate is located at least partially overlaps with the projection of the slit between adjacent drive electrodes on the plane where the first substrate is located; the sensing electrode includes at least one first branch electrode and at least second branch electrode, the at least one first branch electrode extends along the first direction, the at least one second branch electrode extends along the second direction, the first direction is parallel to the row direction of the array where the multiple drive electrodes are arranged, and the second direction is parallel to the column direction of the array where the multiple drive electrodes are arranged. In this manner, the position of the droplet may be acquired when the droplet is driven to move, and to solve the problem of low reliability of a device due to the inability to detect the position of the droplet in the related art.

The embodiments of the present application are described clearly and completely hereinafter in conjunction with the drawings in the embodiments of the present application.

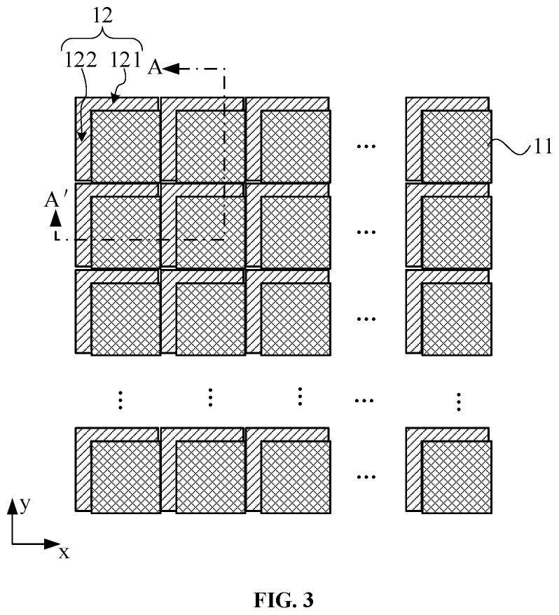

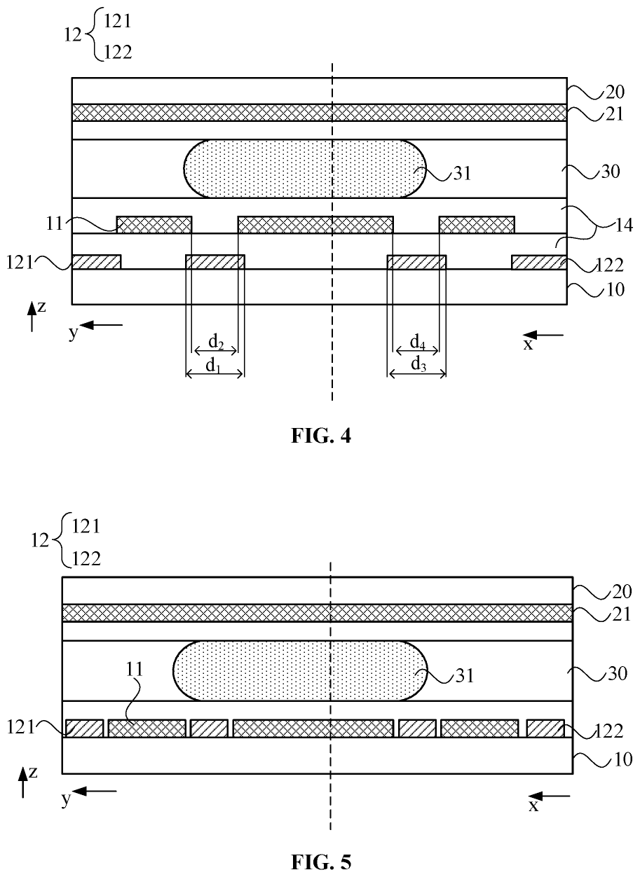

Exemplarily, FIG. 3 is a structural diagram of a microfluidic chip according to an embodiment of the present application, and FIG. 4 is a sectional diagram taken along line AA′ of FIG. 3. FIG. 3 shows a top diagram of the microfluidic chip. The microfluidic chip includes multiple drive electrodes 11 and multiple sensing electrodes 12, where the multiple drive electrodes 11 are arranged in an array, different drive voltages are applied to adjacent drive electrodes 11, and the droplet is driven by a differential voltage between adjacent drive electrodes 11 and controlled to move according to a preset path. Exemplarily, in FIG. 3, the case where the sensing electrode includes one first branch electrode 121 and one second branch electrode 122 is used as an example. The first branch electrode 121 and the second branch electrode 122 are designed in an inverted “L” shape, where the first branch electrode 121 extends along a first direction x, the second electrode 122 extends along a second direction y, the first direction x is parallel to the row direction of the array where the multiple drive electrodes 11 are arranged, and the second direction y is parallel to the column direction of the array where the multiple drive electrodes 11 are arranged. A rectangular shape of the drive electrode 11 shown in FIG. 3 is only schematic and may be set according to actual conditions during implementation. Referring to FIG. 4, the microfluidic chip includes a first substrate 10 and a second substrate 20 disposed opposite to each other, and a microfluidic channel 30 is formed between the first substrate 10 and the second substrate 20 and configured to accommodate at least one droplet 31. Exemplarily, in this embodiment, the drive electrodes 11 and the sensing electrodes 12 are all located on a side of the first substrate 10 facing toward the second substrate 20, an insulating layer 14 is disposed between different electrode layers, a direction z points to the second substrate 20 from the first substrate 10, the first branch electrode 121 covers the slit between two adjacent rows of drive electrodes 11, and the second branch electrode 122 covers the slit between two adjacent columns of drive electrodes 11. That is, in the embodiment of FIG. 4, a width d1 of the first branch electrode 121 is greater than a width d2 of the slit between two adjacent rows of drive electrodes 11, and a width d3 of the second branch electrode 122 is greater than a width d4 of the slit between two adjacent columns of drive electrodes 11. The width of the first branch electrode 121 and the width of the second branch electrode 122 are relatively wide, which is conducive to reducing the resistance of the sensing electrode 12 and reducing the voltage drop when the detection signal is applied. In other embodiments, the width of the first branch electrode 121 may also be less than or equal to the width of the slit between two adjacent rows of drive electrodes 11, and the width of the second branch electrode 122 is less than or equal to the width of the slit between two adjacent columns of drive electrodes 11, which may be set according to actual conditions during implementation. The width of the sensing electrode and the width of the slit between the drive electrodes are not limited in the embodiments of the present application. FIG. 4 exemplarily shows that a common electrode 21 is further disposed on a side of the second substrate 20 and may be formed by ITO. When detection signals are applied to the sensing electrodes 12, the first branch electrode 121 and the second branch electrode 122 in at least one sensing electrode 12 and the common electrode 21 form capacitors. When the droplet flows by, a dielectric constant between the sensing electrode and the common electrode changes, and the capacitance between the sensing electrode 12 and the common electrode 21 changes and the position of the droplet is determined according to the change in the capacitance between the sensing electrode 12 and the common electrode 21. In other embodiments, another electrode that forms a capacitor with the sensing electrode may also be a trace in the microfluidic chip or an electrode of other capacitors, which may be designed according to actual conditions during implementation.

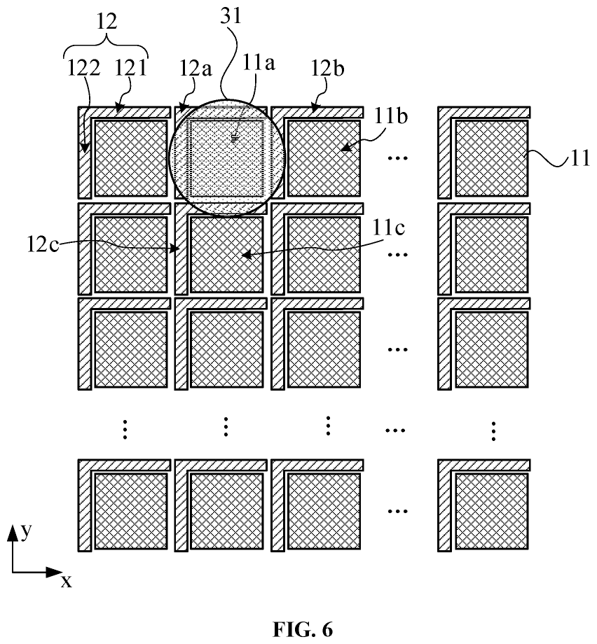

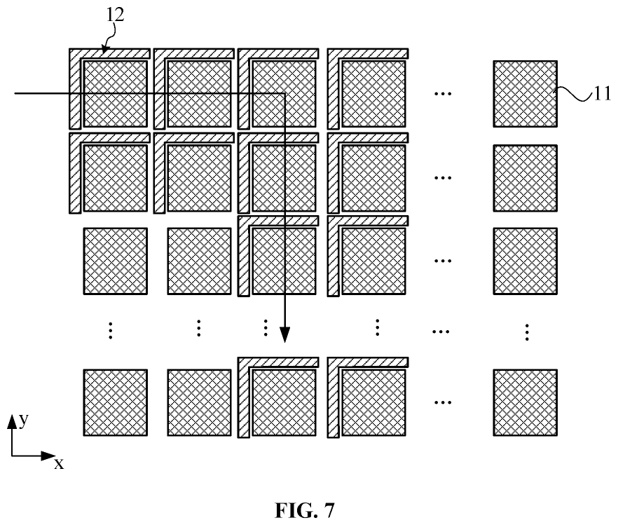

FIG. 5 is another sectional diagram taken along line AA′ of FIG. 3. In one embodiment, the sensing electrodes 12 and the drive electrodes 11 are disposed in a same layer and made of a same material. During preparation, the sensing electrodes 12 and the drive electrodes may be formed at one time by a same process, and reducing the preparation cost of the microfluidic chip. When the sensing electrodes 12 and the drive electrodes 11 are disposed on the same layer, to avoid short circuit in the electrical connection between the sensing electrodes 12 and the drive electrodes 11, the difference from the embodiment of FIG. 4 in which the width of the sensing electrode 12 is greater than the width of the slit between two adjacent drive electrodes 11 is that in this embodiment, the width of the sensing electrode 12 is less than the width of the slit between two adjacent drive electrodes 11. Exemplarily, the width of the first branch electrode 121 is less than the width of the slit between two adjacent rows of drive electrodes 11, and the width of the second branch electrode 122 is less than the width of the slit between two adjacent columns of drive electrodes 11, that is, the sensing electrode 12 is completely located in the slit between the drive electrodes 11.

FIG. 6 is a structural diagram of another microfluidic chip according to an embodiment of the present application. In one embodiment, referring to FIG. 6, the sensing electrode 12 includes one first branch electrode 121 and one second branch electrode 122, where the first branch electrode 121 and the second branch electrode 122 are connected in a shape of a broken line, and the first branch electrode 121 and the second branch electrode 122 are respectively parallel to two adjacent edges of a corresponding drive electrode 11.

In the embodiment shown in FIG. 6, each sensing electrode 12 includes one first branch electrode 121 and one second branch electrode 122, where the first branch electrode 121 and the second branch electrode 122 are connected in a shape of an inverted “L” broken line, and the sensing electrode 12 is disposed in the slit between the drive electrodes 11. In one embodiment, multiple sensing electrodes 12 are in a one-to-one correspondence with multiple drive electrodes 11. In one embodiment, when the droplet 31 is located above a drive electrode 11a in the first row and the second column, capacitances formed by a sensing electrode 12a parallel to two edges of the drive electrode 11a in the first row and the second column, a sensing electrode 12b parallel to two edges of a drive electrode 11b in the first row and the third column, a sensing electrode 12c parallel to two edges of a drive electrode 11c in the second row and the second column and an electrode change, and the variation of the capacitance between the sensing electrode 12a is greater than the variation of the capacitance between the sensing electrode 12b and the variation of the capacitance between the sensing electrode 12c, and determining the position of the droplet 31.

In one embodiment, the number of the multiple sensing electrodes is less than the number of the multiple drive electrodes. In other embodiments, to reduce the driving cost of the microfluidic chip, the sensing electrodes may be disposed only at key positions of the droplet path, such as the path through which the droplet flows by and the position of the droplet turning. Exemplarily, FIG. 7 is a structural diagram of another microfluidic chip according to an embodiment of the present application. Referring to FIG. 7, the moving path of the droplet is along a direction of an arrow in FIG. 7, and the sensing electrodes 12 are arranged around the drive electrodes 11 near the moving path of the droplet, where the moving path of the droplet and the setting positions of the sensing electrodes 12 shown in FIG. 7 are only schematic and may be designed according to actual conditions during implementation, which is not limited in the embodiments of the present application.

In one embodiment, each sensing electrode surrounds a corresponding drive electrode, and the sensing electrodes are arranged in alternate rows and/or alternate columns relative to the array formed by the multiple drive electrodes.

In the preceding embodiments, one sensing electrode includes one first branch electrode and one second branch electrode. In other embodiments, the number of branch electrodes in one sensing electrode may be greater than two (for example, one sensing electrode may include one first branch electrode and two second branch electrodes). Since at least part of the sensing electrode is disposed in the slit between the drive electrodes, the sensing electrode may surround a corresponding drive electrode, and the sensing electrodes are arranged in alternate rows and/or alternate columns relative to the array formed by the drive electrodes, and reducing the number of sensing electrodes and signal lines, simplifying the structure of the microfluidic chip, and reducing the driving cost of the microfluidic chip.

In one embodiment, the sensing electrode includes one first branch electrode and two second branch electrodes; each sensing electrode surrounds one drive electrode corresponding to each sensing electrode in an odd or even column in the array formed by multiple drive electrodes.

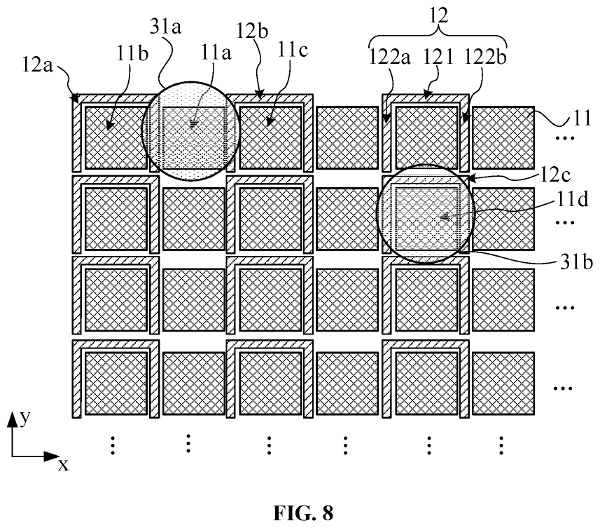

Exemplarily, FIG. 8 is a structural diagram of another microfluidic chip according to an embodiment of the present application. Referring to FIG. 8, the sensing electrode 12 includes a first branch electrode 121, a second branch electrode 122a and a second branch electrode 122b. That is, the sensing electrode 12 is designed in a shape similar to a “door frame”; each sensing electrode 12 surrounds a drive electrode 11 corresponding to an odd column in the array formed by the multiple drive electrodes 11, and comprehensively tracking positions of all droplets. For example, a droplet 31a in FIG. 8 is located above the drive electrode 11a in the first row and the second column. Although a sensing electrode surrounding the drive electrode 11a is not provided, capacitances of the sensing electrode 12a adjacent to the drive electrode 11b in the first row and the first column and the sensing electrode 12b adjacent to the drive electrode 11c in the first row and the third column (left and right sides of the droplet 31a) both change, and the variations are different from the variation when the droplet is located above the drive electrode 11b or the drive electrode 11c, and determining the position of the droplet 31a through the change of capacitance and the related positioning algorithm. When a droplet 31b is located above a drive electrode 11d in the second row and the fifth column, the capacitance of the sensing electrode 12c surrounding the drive electrode 11d (left, upper and right sides of the droplet 31b) changes, and determining the position of the droplet 31b.

In other embodiments, each sensing electrode may surround one drive electrode corresponding to each sensing electrode in an even column in the array formed by multiple drive electrodes, and the structure is similar to the structure in FIG. 8, which is not described in detail here.

In one embodiment, the sensing electrode includes one second branch electrode and two first branch electrodes; each sensing electrode surrounds one drive electrode corresponding to each sensing electrode in an odd or even row in the array formed by multiple drive electrodes.

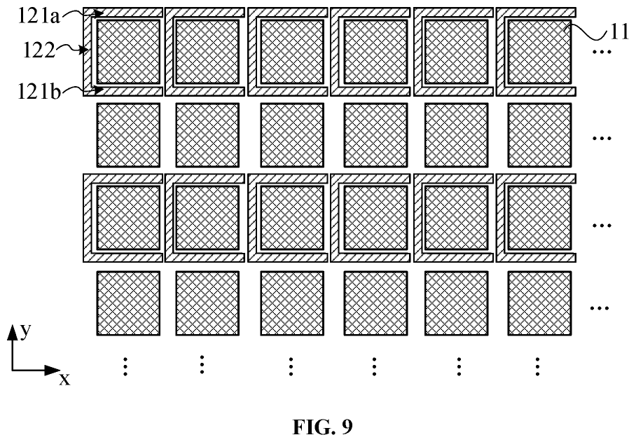

Exemplarily, FIG. 9 is a structural diagram of another microfluidic chip according to an embodiment of the present application. Referring to FIG. 9, the sensing electrode 12 includes a second branch electrode 122, a first branch electrode 121a and a first branch electrode 122b. That is, the sensing electrode 12 is designed in a shape similar to “C”; each sensing electrode 12 surrounds a drive electrode 11 corresponding to an odd row in the array formed by the drive electrodes 11, and comprehensively tracking positions of all droplets. In other embodiments, the opening of the sensing electrode 12 may also be configured to face upwards or to the left, and the implementation manner is similar to the implementation manner in FIG. 8 or 9, which may be designed according to actual conditions during implementation.

It is to be understood that when the droplet moves in the microfluidic chip, the positioning principle is similar to the positioning principle in the embodiment shown in FIG. 7. In other embodiments, each sensing electrode may surround one drive electrode corresponding to an even column in the array formed by the drive electrodes, and the structure is similar to the structure in FIG. 9, which is not described in detail here.

In one embodiment, the sensing electrode includes one first branch electrode and two second branch electrodes or the sensing electrode includes one second branch electrode and two first branch electrodes, where along the first direction, the sensing electrode surrounds one of two adjacent drive electrodes; and along the second direction, the sensing electrode surrounds one of two adjacent drive electrodes.

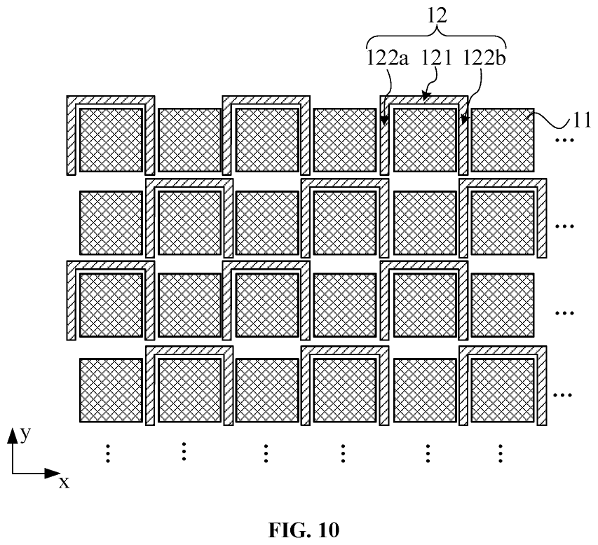

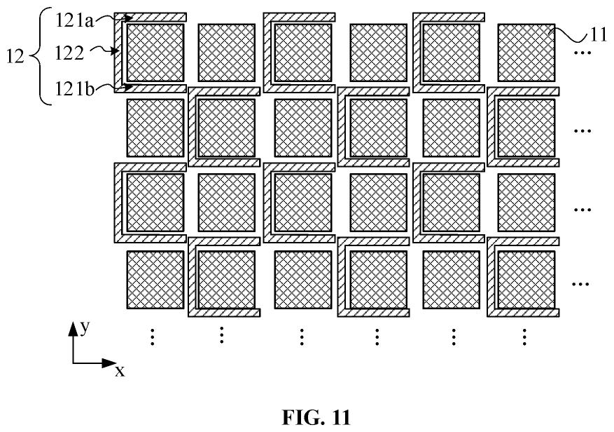

Exemplarily, FIG. 10 is a structural diagram of another microfluidic chip according to an embodiment of the present application. Referring to FIG. 10, the sensing electrode 12 includes one first branch electrode 121, a second branch electrode 122a and a second branch electrode 122b, where along the first direction x, the sensing electrode 12 surrounds one of two adjacent drive electrodes 11; and along the second direction y, the sensing electrode 12 surrounds one of two adjacent drive electrodes 11. During implementation, for the drive electrodes 11 at the edge, to prevent inaccurate positioning of the droplet at the edge, strip-shaped branch electrodes may be designed at the edge, which may be designed according to actual situations during implementation. FIG. 11 is a structural diagram of another microfluidic chip according to an embodiment of the present application. Referring to FIG. 11, the sensing electrode 12 includes a second branch electrode 122, a first branch electrode 121a and a first branch electrode 121b, where along the first direction x, the sensing electrode 12 surrounds one of two adjacent drive electrodes 11; along the second direction y, the sensing electrode 12 surrounds one of two adjacent drive electrodes 11; and compared with an arrangement where multiple sensing electrodes are in a one-to-one correspondence with multiple drive electrodes, this arrangement can reduce the number of sensing electrodes and signal lines and reduce the driving cost.

In one embodiment, each sensing electrode includes two first branch electrodes and two second branch electrodes, where the two first branch electrodes and the two second branch electrodes are connected in an annular shape surrounding the drive electrode. In one embodiment, the sensing electrodes are arranged in alternate rows and columns relative to the array formed by multiple drive electrodes.

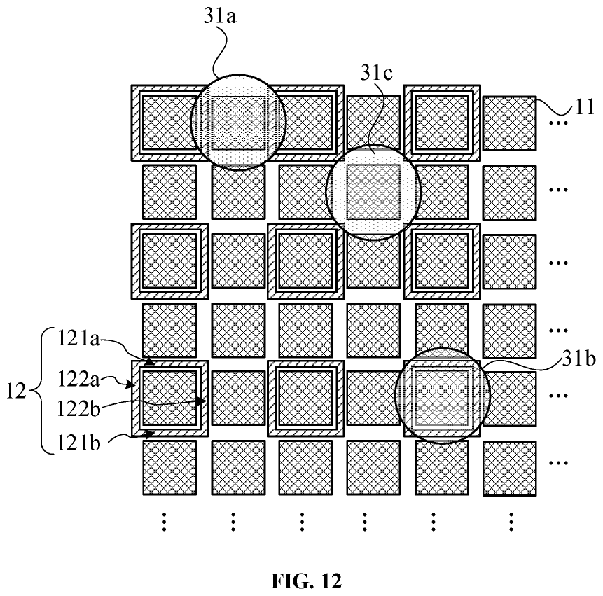

Exemplarily, FIG. 12 is a structural diagram of another microfluidic chip according to an embodiment of the present application. Referring to FIG. 12, each sensing electrode 12 includes a first branch electrode 121a, a first branch electrode 121b, a second branch electrode 122a and a second branch electrode 122b, where the first branch electrode 121a, the first branch electrode 121b, the second branch electrode 122a and the second branch electrode 122b are connected in an annular shape surrounding the drive electrode 11, and the sensing electrodes 12 are designed in alternate rows and columns, and comprehensively tracking droplets at all positions. A droplet 31a, a droplet 31b and a droplet 31c are used as an example. An identification method of the droplet 31a and the droplet 31b is similar to the method in FIG. 8, that is, the capacitances of two sensing electrodes on the left and right sides of the droplet 31a change and it may be determined that the droplet 31a is located between two sensing electrodes 12 according to the variations of the capacitances of the two sensing electrodes 12. The droplet 31b only causes the variation of the capacitance of one sensing electrode 12 below. Capacitances of four sensing electrodes 12 on the upper left, lower left, upper right and lower right sides of the droplet 31c change, and the variation caused by the droplet 31c is less than the variation caused by the droplet 31a which is less than the variation caused by the droplet 31b and it may be determined that the droplet 31c is located among the four sensing electrodes 12 through signals of the capacitance variation of the four sensing electrodes 12. In addition, the sensing electrodes are arranged in alternate rows and columns, and reducing the number of signal lines and the driving cost.

In one embodiment, each sensing electrode includes two first branch electrodes and two second branch electrodes, and the two first branch electrodes and the two second branch electrodes are connected in an annular shape surrounding the drive electrode; where a length of one first branch electrode in the sensing electrode or a length of one second branch electrode in the sensing electrode is greater than a length of each of remaining three branch electrodes.

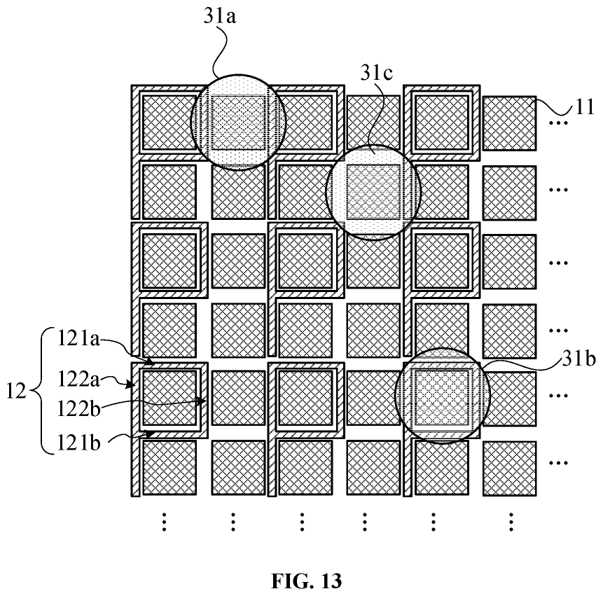

Exemplarily, FIG. 13 is a structural diagram of another microfluidic chip according to an embodiment of the present application. Referring to FIG. 13, each sensing electrode 12 includes a first branch electrode 121a, a first branch electrode 121b, a second branch electrode 122a and a second branch electrode 122b, where a length of the second branch electrode 122a is greater than a length of each of the first branch electrode 121a, the first branch electrode 121b and the second branch electrode 122b, that is, the sensing electrode 12 forms a shape similar to “P”.

Compared with the microfluidic chip shown in FIG. 12, a protruding part of the second branch electrode 122a in the sensing electrode on the upper right side of the droplet 31c has a larger overlap with the droplet 31c, and ensuring the signal strength. In this manner, the problem in which the droplet 31c only overlaps with one corner of each of four sensing electrodes 12 and the capacitance variation is relatively small and cannot be detected may be avoided, and improving the detection accuracy of the droplet position. The droplet 31c has no apparent overlap with the upper left sensing electrode, and to be distinguished from the droplet 31a, and in this embodiment, assuming that the capacitance variation caused by the droplet 31c is A, then the capacitance variation caused by the droplet 31a is about 2 A and the capacitance variation caused by the droplet 31b is about 4 A. In other embodiments, an extension length of one branch electrode among the first branch electrode 121a, the first branch electrode 121b or the second branch electrode 122b may also be configured to be greater than the length of each of the other three branch electrodes. In one embodiment, the length of one first branch electrode in the sensing electrode or one second branch electrode in the sensing electrode is 1.8 to 2.2 times the length of each of the remaining three branch electrodes, which may be designed according to actual conditions during implementation and not be limited in the embodiments of the present application.

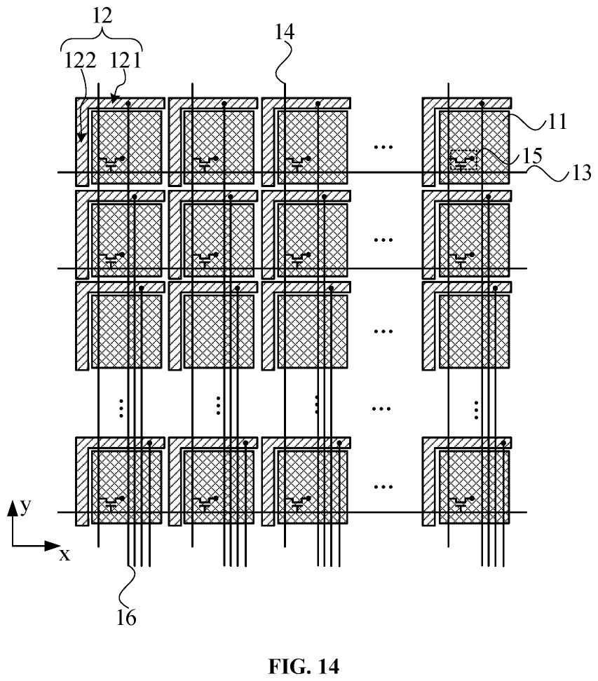

FIG. 14 is a structural diagram of a circuit of a microfluidic chip according to an embodiment of the present application. Referring to FIG. 14, In one embodiment, the microfluidic chip provided in this embodiment further includes multiple scan signal lines 13 extending along the first direction x, multiple data signal lines 14 extending along the second direction y, and multiple transistors 15 in a one-to-one correspondence with the multiple drive electrodes 11, where a gate of each transistor 15 is connected to one scan signal line 13, a first electrode of each transistor 15 is connected to one data signal line 14, and a second electrode of each transistor 15 is connected to a corresponding drive electrode 11.

It is to be understood that, for a microfluidic chip with a large number of drive electrodes and a relatively complicated structure, an active driving method including the scan signal lines 13, the data signal lines 14 and the transistors 15 may be provided. Similar to a display panel, each drive electrode 11 is similar to one sub-pixel in the display panel, the scan signal lines 13 and the data signal lines 14 are used for scanning, and the active driving of the drive electrodes 11 is achieved through the on-off of the transistors 15, where the first electrode of the transistor 15 may be a source, the second electrode may be a drain, and the transistor 15 may be a thin film transistor. Exemplarily, a thin film transistor formed with amorphous silicon material, polysilicon material or metal oxide material as an active layer may be adopted. In one embodiment, the scan signal line, the data signal line and the transistor are all disposed on a side of the drive electrode farther away from the second substrate; and at least one of the scanning signal line, the data signal line, or the transistor overlaps with the drive electrode. It is to be noted that the overlap in the present application refers to overlapping of vertical projections on the plane where the first substrate is located.

Exemplarily, FIG. 15 is a sectional diagram of a microfluidic chip according to an embodiment of the present application. Referring to FIG. 15, the transistor 15 includes a gate 151, an active layer 152, a source 153 (a first electrode), and a drain 154 (a second electrode), and the scan signal line 13, the data signal line 14 and the transistor 15 are all disposed on a side of the drive electrode 11 farther away from the second substrate 20. In this embodiment, since the sensing electrode 12 needs to be at least partially disposed in the slit between the drive electrodes 11, to ensure the strength of the positioning signal and reduce the signal interference, the scan signal line 13 and/or the data signal line 14 are not routed in the slit between the drive electrodes 11 and are both located below the drive electrodes 11. Correspondingly, the transistor 15 is also disposed below the drive electrodes 11 and not in the slit. In this manner, the drive electrodes 11 may shield the parasitic capacitance caused by the scan signal line 13, the data signal line 14 or the transistor 15, and improving the positioning accuracy of the droplet and avoiding a reaction force to the movement of the droplet generated between the scan signal line 13/the data signal line 14 and the drive electrode 11.

It is to be understood that, in the sectional structure shown in FIG. 15, the shape of the section line is similar to the broken line AA′ in FIG. 3, where the section line on the left side of a dashed line extends along the first direction x (the row direction of the drive electrode array), the section line on the right side of the dashed line extends along the second direction y (the column direction of the drive electrode array), and the scan signal line 13 is connected to the gate 151 of the transistor 15. Since the structure of a position where the scan signal line 13 is connected to the gate 151 is not shown in FIG. 15, the structure of the scan signal line and the connection between the data signal line 14 and the source 153 of the transistor 15 are not shown in FIG. 15, and FIG. 15 shows that the data signal line 14 and the source 153 are connected as one integrated structure.

Referring to FIGS. 14 and 15, In one embodiment, the microfluidic chip further includes multiple detection signal lines 16, where each detection signal line 16 is connected to one sensing electrode 12 through a via hole 18, and the detection signal lines 16 and the data signal lines 14 are disposed in a same layer and in parallel. During implementation, the detection signal lines 16 and the data signal lines 14 may be formed at one time using the same process and material, and simplifying the process steps and reducing the cost.

In this embodiment, the detection signal lines 16 are also disposed below the drive electrodes and the detection signal line 16 may be prevented from affecting a driving electric field generated by two adjacent drive electrodes 11.

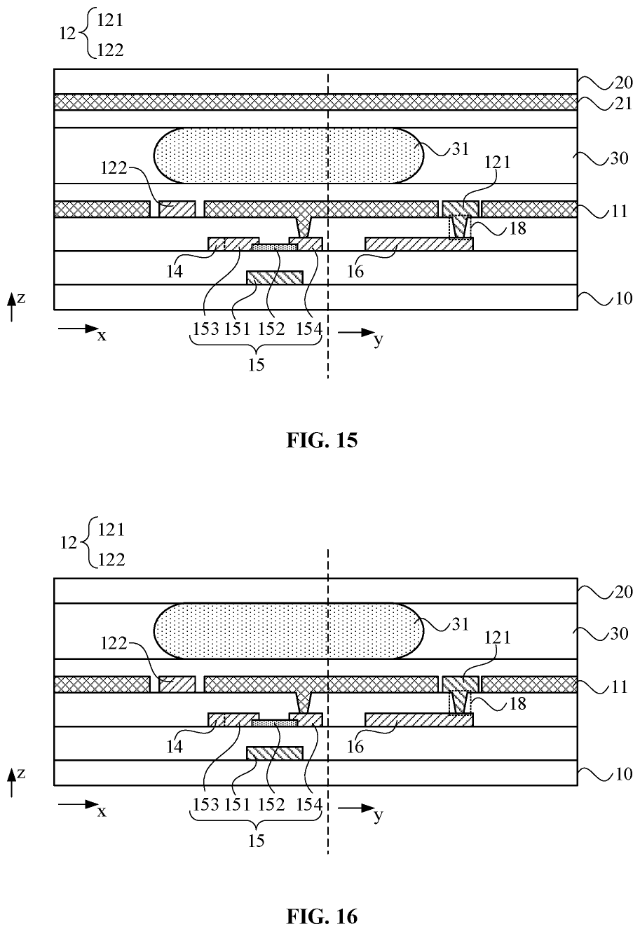

FIG. 16 is a sectional diagram of another microfluidic chip according to an embodiment of the present application. Referring to FIG. 16, it is to be understood that the driving of the droplet to move and the detection of the position of the droplet are generally performed at different times.

In this embodiment, when a detection signal is applied to the sensing electrode, the sensing electrode 12 may form a capacitance with the scan signal line 14 (in other embodiments, other signal lines or electrodes, which are not limited in the embodiments of the present application). When the droplet flows by, the induced charge distribution in the droplet is changed through the influence of the sensing electrode, and then the capacitance between the sensing electrode 12 and the scan signal line 14 changes, and determining the position of the droplet according to the capacitance variation.

In another embodiment, for example, in the case where the number of drive electrodes of the microfluidic chip is relatively small and the structure is relatively simple, a passive driving method may be adopted, that is, no transistors are provided. In one embodiment, the microfluidic chip provided in this embodiment further includes multiple data signal lines extending along the first direction or the second direction, where each data signal line is connected to a respective drive electrode, and the data signal line is disposed on a side of the drive electrode farther away from the second substrate; and the data signal line overlaps with and is insulated from the drive electrode.

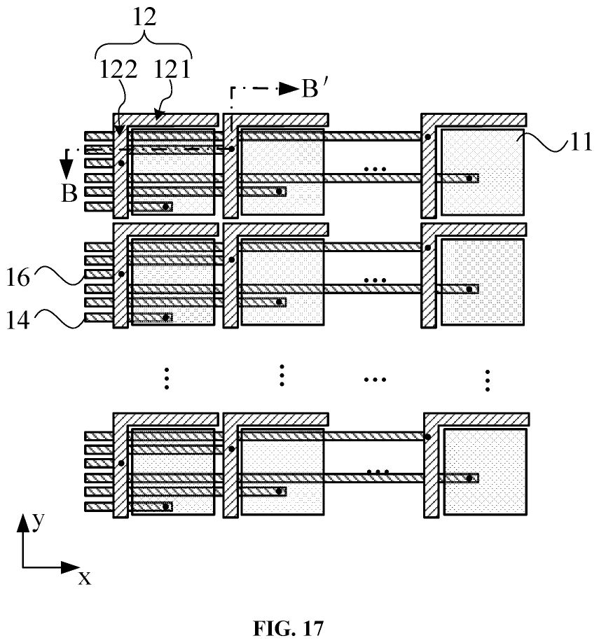

Exemplarily, the case where the data signal line extends along the first direction is used as an example. FIG. 17 is a structural diagram of another microfluidic chip according to an embodiment of the present application. Referring to FIG. 17, the microfluidic chip further includes multiple data signal lines 14 extending along the first direction x, where each data signal line 14 is connected to a respective drive electrode 11. During implementation, a via hole may be disposed in a film layer between the data signal line 14 and the drive electrode 11, and to achieve electrical connection. In other embodiments, the data signal lines may also extend along the second direction and the structure is similar to the structure in FIG. 17, except that the data signal lines extend along the column direction of the drive electrode array in the case where the data signal lines extend along the second direction.

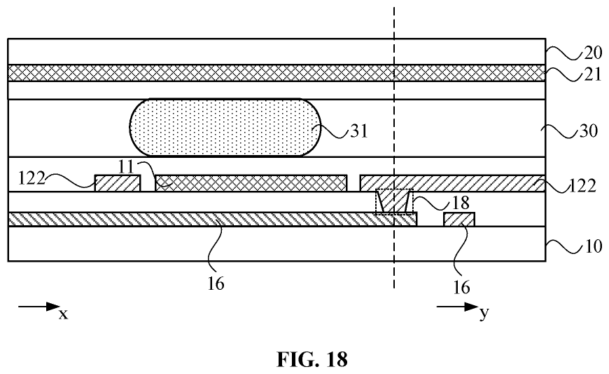

Referring to FIG. 17, In one embodiment, the microfluidic chip further includes multiple detection signal lines 16. FIG. 18 is a sectional diagram taken along line BB′ of FIG. 17. Referring to FIG. 18, each detection signal line 16 is connected to one sensing electrode 12 through the via hole 18, and the detection signal lines 16 and the data signal lines 14 are disposed in a same layer and in parallel. During implementation, the detection signal lines 16 and the data signal lines 14 may be formed at one time using the same process and material, and simplifying the process steps and reducing the cost.

In the microfluidic chip, the dimension of the drive electrode is generally in the order of millimeters, and the distance between the drive electrodes may be several tens of micrometers. In one embodiment, along the first direction, the distance between two adjacent drive electrodes is 10 μm to 40 μm; and along the second direction, the distance between two adjacent drive electrodes is 10 μm to 40 μm, and ensuring a relatively large area of the sensing electrode and the signal strength during detection of the droplet position. In other embodiments, In one embodiment, an insulating hydrophobic layer is disposed on a side of each of the first substrate and the second substrate facing toward the microfluidic channel, and to achieve insulation and reduce the movement resistance of the droplet.

1. A microfluidic chip, comprising:
a first substrate and a second substrate disposed opposite to each other, wherein a microfluidic channel is formed between the first substrate and the second substrate and configured to accommodate at least one droplet; and
a plurality of drive electrodes and a plurality of sensing electrodes disposed on a side of the first substrate, wherein the plurality of drive electrodes are arranged in an array, and a projection of each of the plurality of sensing electrodes on a plane where the first substrate is located at least partially overlaps with a projection of a slit between two drive electrodes of the plurality of drive electrodes adjacent to the each of the plurality of sensing electrodes on the plane where the first substrate is located;
wherein each of the plurality of sensing electrodes comprises at least one first branch electrode and at least one second branch electrode, the at least one first branch electrode extends along a first direction, the at least one second branch electrode extends along a second direction, the first direction is parallel to a row direction of the array where the plurality of drive electrodes are arranged, and the second direction is parallel to a column direction of the array where the plurality of drive electrodes are arranged;
different drive voltage signals are applied to adjacent ones of the plurality of drive electrodes, to drive the at least one droplet to move; and
a detection signal is applied to each of the plurality of sensing electrodes, and a position of the at least one droplet is determined according to a change in capacitance between a sensing electrode of the plurality of sensing electrodes and an electrode corresponding to the sensing electrode when the at least one droplet flows by.

2. The microfluidic chip of claim 1, wherein each of the plurality of sensing electrodes comprises one first branch electrode and one second branch electrode, the first branch electrode and the second branch electrode are connected in a shape of a broken line, and the first branch electrode and the second branch electrode are respectively parallel to two adjacent edges of a corresponding one of the plurality of drive electrodes.

3. The microfluidic chip of claim 2, wherein the plurality of sensing electrodes are in a one-to-one correspondence with the plurality of drive electrodes.

4. The microfluidic chip of claim 2, wherein a number of the plurality of sensing electrodes is less than a number of the plurality of drive electrodes.

5. The microfluidic chip of claim 1, wherein each of the plurality of sensing electrodes surrounds a respective one of the plurality of drive electrodes, and the plurality of sensing electrodes satisfy at least one of the following: the plurality of sensing electrodes are arranged in alternate rows relative to the array where the plurality of drive electrodes are arranged; or the plurality of sensing electrodes are arranged in alternate columns relative to the array where the plurality of drive electrodes are arranged.

6. The microfluidic chip of claim 5, wherein each of the plurality of sensing electrodes comprises one first branch electrode and two second branch electrodes; and
each of the plurality of sensing electrodes surrounds one of the plurality of drive electrodes corresponding to the each of the plurality of sensing electrodes in an odd or even column in the array where the plurality of drive electrodes are arranged.

7. The microfluidic chip of claim 5, wherein each of the plurality of sensing electrodes comprises one second branch electrode and two first branch electrodes; and
each of the plurality of sensing electrodes surrounds a drive electrode of the plurality of drive electrodes corresponding to the each of the plurality of sensing electrodes in an odd row or an even row in the array where the plurality of drive electrodes are arranged.

8. The microfluidic chip of claim 5, wherein each of the plurality of sensing electrodes comprises one first branch electrode and two second branch electrodes or each of the plurality of sensing electrodes comprises one second branch electrode and two first branch electrodes;
along the first direction, each of the plurality of sensing electrodes surrounds one of two adjacent ones of the plurality of drive electrodes; and
along the second direction, each of the plurality of sensing electrodes surrounds one of two adjacent ones of the plurality of drive electrodes.

9. The microfluidic chip of claim 1, wherein each of the plurality of sensing electrodes comprises two first branch electrodes and two second branch electrodes, and the two first branch electrodes and the two second branch electrodes are connected in an annular shape surrounding one of the plurality of drive electrodes.

10. The microfluidic chip of claim 9, wherein the plurality of sensing electrodes are arranged in alternate rows and alternate columns relative to the array where the plurality of drive electrodes are arranged.

11. The microfluidic chip of claim 1, wherein each of the plurality of sensing electrodes comprises two first branch electrodes and two second branch electrodes, and the two first branch electrodes and the two second branch electrodes are connected in an annular shape surrounding one of the plurality of drive electrodes;
wherein a length of one of the two first branch electrodes in each of the plurality of sensing electrodes or a length of one of the two second branch electrodes in each of the plurality of sensing electrodes is greater than a length of each of remaining three branch electrodes.

12. The microfluidic chip of claim 11, wherein the length of one of the two first branch electrodes in each of the plurality of sensing electrodes or the length of one of the two second branch electrodes in each of the plurality of sensing electrodes is 1.8 to 2.2 times the length of each of the remaining three branch electrodes.

13. The microfluidic chip of claim 1, further comprising a plurality of scan signal lines extending along the first direction, a plurality of data signal lines extending along the second direction, and a plurality of transistors in a one-to-one correspondence with the plurality of drive electrodes, wherein a gate of each of the plurality of transistors is connected to one of the plurality of scan signal lines, a first electrode of each of the plurality of transistors is connected to one of the plurality of data signal lines, and a second electrode of each of the plurality of transistors is connected to a respective one of the plurality of drive electrodes.

14. The microfluidic chip of claim 13, wherein each of the plurality of scan signal lines, each of the plurality of data signal lines, and each of the plurality of transistors are all disposed on a side of one of the plurality of drive electrodes farther away from the second substrate; and
at least one of each of the plurality of scan signal lines, each of the plurality of data signal lines, or each of the plurality of transistors overlaps with one of the plurality of drive electrodes.

15. The microfluidic chip of claim 1, wherein the plurality of sensing electrodes and the plurality of drive electrodes are disposed in a same layer and made of a same material.

16. The microfluidic chip of claim 1, further comprising a plurality of data signal lines extending along the first direction or the second direction, wherein each of the plurality of data signal lines is connected to a respective one of the plurality of drive electrodes, and each of the plurality of data signal lines is disposed on a side of a respective one of the plurality of drive electrodes farther away from the second substrate; and
each of the plurality of data signal lines overlaps with and is insulated from the respective one of the plurality of drive electrodes.

17. The microfluidic chip of claim 13, further comprising a plurality of detection signal lines, wherein each of the plurality of detection signal lines is connected to one of the plurality of sensing electrodes through a via hole, and the plurality of detection signal lines and the plurality of data signal lines are disposed in a same layer and in parallel.

18. The microfluidic chip of claim 1, further comprising a common electrode disposed on a side of the second substrate, wherein the position of the at least one droplet is determined according to a change in capacitance between one of the plurality of sensing electrodes and the common electrode when the at least one droplet flows by.

19. The microfluidic chip of claim 1, wherein a distance between two adjacent ones of the plurality of drive electrodes along the first direction is 10 μm to 40 μm; and
a distance between two adjacent ones of the plurality of drive electrodes along the second direction is 10 μm to 40 μm.

20. The microfluidic chip of claim 1, wherein an insulating hydrophobic layer is disposed on a side of each of the first substrate and the second substrate facing toward the microfluidic channel.
